(19) United States
(12) Patent Application Publication
(10) Pub. No.: US 2006/0114178 A1
(43) Pub. Date: Jun. 1, 2006

(54) Plasma display apparatus and method for driving the same

(76) Inventors: Hee Chan Yang, Busan (KR); Jin Young Kim, Daegu (KR); Yun Kwon Jung, Gumi-si (KR)

Correspondence Address: MCKENNA LONG & ALDRIDGE LLP;Song K. Jung, 1900 K Street, N.W., Washington, DC, 20006, US

(21) Appl. No.: 11/159,339

(22) Filed: Jun. 23, 2005

(30) Foreign Application Priority Data
Nov. 16, 2004 (KR) 10-2004-0093727

(51) Int. Cl. G09G 3/28

(52) U.S. Cl. 345/60

(57) ABSTRACT

The present invention provides a method of driving a plasma display panel that reduces the noise generated in the waveforms applied to a scan electrode, or a sustain electrode, and prevents deterioration of address jitters, thereby stabilizing an address discharge. A plasma display device comprises a scan electrode, a sustain electrode, and a plurality of address electrodes intersecting said scan electrode and said sustain electrode, a scan driving unit for driving the scan electrode, a data driving unit for driving the address electrode, and a timing controller unit for setting an application time point of data pulses applied to at least one electrode group of electrode groups, into which the plurality of address electrodes are divided during the address period to be different from an application time point of a scan pulse applied to the scan electrode, in the remaining sub-fields except an arbitrary sub-field of the sub-fields of a frame, by controlling the scan driving unit and the data driving unit.

This application claims the benefit of Korean Patent Application No. 10-2004-0093727 filed on Nov. 16, 2004, which is hereby incorporated by reference for all purposes as if fully set forth herein.

### BACKGROUND OF THE INVENTION

1. Field of the Invention

The present invention relates to a plasma display panel; and more specifically to a plasma display apparatus and method of driving same which reduces the noise generated in the waveforms applied to a scan electrode, or a sustain electrode by improving the application time point of pulses applied during the address period, and enhances the driving efficiency by preventing a deterioration of the address jitter characteristics, and stabilizing the address discharge.

2. Description of the Background Art

Generally, in a plasma display panel, barrier ribs formed between a front substrate and a rear substrate form unit or discharge cells. Each of the cells is filled with a main discharge gas, such as neon (Ne), helium (He), or a mixture of Ne and He, and an inert gas containing a small amount of xenon. When it is discharged by a high frequency voltage, the inert gas generates vacuum ultraviolet rays, which thereby cause phosphors formed between the barrier ribs to emit light, thus displaying an image. Because the plasma display panel can be made with a thin and/or slim form, it has attracted attention as a next-generation display device.

FIG. 1 is a perspective view illustrating the configuration of a conventional plasma display panel. As shown in FIG. 1, the plasma display panel includes a front substrate 100 and a rear substrate 110 disposed parallel to each other with a gap in-between. The front substrate 100 has a plurality of electrode pairs arranged on a front glass 101, which serves as the display surface. Each electrode pair is formed of a scan electrode 102 and a sustain electrode 103. The rear substrate 110 is provided with a plurality of address electrodes 113 arranged on a rear glass 111, which constitutes a rear surface. The address electrode 113 is formed so as to cross the electrode pairs 102 and 103.

Both the scan electrode 102 and the sustain electrode 103 are formed of a transparent electrode “a” made of a transparent ITO material and a bus electrode “b” made of a metallic material. The scan electrode 102 and the sustain electrode 103 are covered with one or more upper dielectric layers 104 to limit discharge current and provide insulation among the electrode pairs. A protection layer 105 having magnesium oxide (MgO) deposited thereon in order to facilitate a discharge condition is formed on top of the upper dielectric layer 104.

In the rear substrate 110, barrier ribs 112 are arranged in the form of a stripe pattern (or a well type) such that a plurality of discharge spaces or discharge cells are formed in parallel. Furthermore, a plurality of address electrodes 113 for performing an address discharge to generate vacuum ultraviolet rays are disposed parallel to the barrier ribs 112. The top surface of the rear substrate 110 is coated with R, G, and B phosphors 114 for emitting visible rays for an image display when an address discharge is carried out. A lower dielectric layer 115 is formed between the address electrodes 113 and the phosphors 114 for protecting the address electrodes 113.

The plasma display panel includes a plurality of discharge cells in a matrix formation, and is provided with a driving module (not shown) having a driving circuit for supplying a predetermined pulse to the discharge cells. The interconnection between the plasma display panel and the driving module is illustrated in FIG. 2.

As illustrated in FIG. 2, the driving module includes, for example, a data driver integrated circuit (IC) 20, a scan driver IC 21, and a sustain board 23. The data driver IC 20 supplies a data pulse to the plasma display panel 22 after an image signal is processed. Also, the plasma display panel receives a scan pulse and a sustain pulse output from the scan driver IC 21 and a sustain signal output from the sustain board 23. A discharge is generated in a cell selected by the scan pulse among the plurality of the cells included in the plasma display panel 22, which has received the data pulse, the scan pulse, the sustain pulse, and the like. The cell where discharge has occurred emits light with a predetermined brightness. Tthe data driver IC 20 outputs a predetermined data pulse to each of the address electrodes X₁ to Xₙ through a connector such as a FPC (Flexible Printed Circuit) (not shown). In this case, the X electrodes refer to the data electrodes.

FIG. 3 illustrates a method for implementing image gradation or gray scale in a conventional plasma display panel. As illustrated in FIG. 3, a frame is divided into a plurality of sub-fields having a different number of emission times. Each sub-field is subdivided into a reset period (RPD) for initializing all the cells, an address period (APD) for selecting the cell(s) to be discharged, and a sustain period (SPD) for implementing the gray scale according to the number of discharges. For example, if an image with 256 gradation levels is to be dipslayed, the frame period (for example, 16.67 ms) corresponding to 1/60 second is divided into eight sub-fields SF1 to SF8, and each of the eight sub-fields SF1 to SF8 are subdivided into a reset period, an address period and a sustain period, as illustrated in FIG. 3.

The reset and address period is the same for every sub-field. However, the sustain period increases by a ratio of 2ⁿ (where, n=0, 1, 2, 3, 4, 5, 6, 7) for each sub-field SF1 to SF8, as shown in FIG. 3. Since the sustain period varies from one sub-field to the next, a specific grey level is achieved by controlling which sustain periods are to be used for discharging each of the selected cells, i.e., the number of the sustain discharges that are realized in each of the discharge cells.

FIG. 4 illustrates a driving waveform according to a conventional method for driving a plasma display panel. As shown, during a given sub-field, the waveforms associated with the X, Y, and Z electrodes are divided into a reset period for initializing all the cells, an address period for selecting the cells to be discharged, a sustain period for maintaining discharging of the selected cells, and an erase period for eliminating wall charges within each of the discharge cells.

he reset period is further divided into a set-up and set-down period. During the set-up period, a ramp-up waveform (Ramp-up) is applied to all the scan electrodes at the same time. This results in wall charges of a positive polarity being built up on the address electrodes and the sustain electrodes, and wall charges of a negative polarity being built up on the scan electrodes.

During the set-down period, a ramp-down waveform (Ramp-down), which falls from a positive polarity voltage lower than the peak voltage of the ramp-up waveform to a given voltage lower than a ground level voltage is applied to all the scan electrode at the same time; causing a weak erase discharge within the cells. Furthermore, the remaining wall charges are uniform inside the cells to the extent that the address charge can be stably performed.

During the address period, a scan pulse with a negative polarity is applied sequentially to the scan electrodes, and a data pulse with a positive polarity is selectively applied to specific address electrodes in synchronization with the scan pulse. As the voltage difference between the scan pulse and the data pulse is added to the wall voltage generated during the reset period, an address discharge is generated in the cells to which the data pulse is applied. A wall charge is formed inside the selected cells such that when a sustain voltage Vs is applied a discharge occurs. A positive polarity voltage Vz is applied to the sustain electrodes so that erroneous discharge does not occur with the scan electrode by reducing the voltage difference between the sustain electrodes and the scan electrodes during the set-down period and the address period.

During the sustain period, a sustain pulse is alternately applied to the scan electrodes and the sustain electrodes. Every time a sustain pulse is applied, a sustain discharge or display discharge is generated in the cells selected during the address period.

Finally, during the erase period, (i.e., after the sustain discharge is completed) an erase ramp waveform (Ramp-ers) having a small pulse width and a low voltage level, is applied to the sustain electrodes to erase the remaining wall charges within all the cells.

As discussed above, during the address period the scan pulses and data pulses have the same application time point (i.e., the pulses are applied to the respective electrodes at the same point in time). As illustrated in FIG. 5, according to the conventional driving method, a data pulse is applied to the address electrodes X₁ to Xₙ, at the same time ts that a scan pulse is applied to the scan electrodes. However, when the data pulse and the scan pulse are applied at the same time, noise occurs in the waveforms applied to the scan and sustain electrodes, as illustrated in FIG. 6.

This noise is generated due to coupling through the capacitance of the panel. As illustrated in FIG. 6, noise is generated in the waveforms applied to the scan electrodes and the sustain electrodes at the leading and trailing edges of the data pulse, i.e., when the data pulse abruptly rises and falls. This noise causes the address discharge to become unstable, thereby degrading the driving efficiency of a plasma display panel.

### SUMMARY OF THE INVENTION

Accordingly, the present invention is directed to a plasma display apparatus and method of driving same that substantially obviates one or more of the problems due to limitations and disadvantages of the related art.

An advantage of the present invention is that it provides a plasma display apparatus and method of driving same which sets the application time point of the data pulses applied to the address electrodes during the address period of a predetermined sub-field to be different from the application time point of the scan pulse applied to the scan electrode.

Additional features and advantages of the invention will be set forth in the description which follows, and inpart will be apparent from the description, or may be learned by practice of the invention. The objective and other advantages of the invention will be realized and attained by the structure particularly pointed out in the written description and claims hereof as well as the appended drawins.

To achieve these and other advantages and in accordance with the purpose of the present invention, as embodied and broadly described, a plasma display apparatus is provided that comprises.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a perspective view illustrating the configuration of a conventional plasma display panel;

FIG. 2 is a diagram illustrating the interconnection a driving module and a plasma display panel according to the related art.

FIG. 3 illustrates a method of implementing gray scale in a related art plasma display panel.

FIG. 4 illustrates a driving waveforms according to a related art method of driving a plasma display panel.

FIG. 5 illustrates application time points of pulses applied during an address period according to a related art method of driving a plasma display panel.

FIG. 6 is a diagram illustrating the noise generation in the related art method of driving a plasma display panel.

FIG. 7 illustrates a plasma display device according to an embodiment of the present invention.

FIG. 8 illustrates driving waveforms according to an embodiment of the present invention.

FIG. 9 is an expanded diagram illustrating region A of FIG. 8.

FIGS. 10a to 10e are expanded diagrams illustrating the waveforms in area B of FIG. 8.

FIGS. 11a and 11b illustrate the reduced noise due to the driving waveforms according to the present invention.

FIG. 12 illustrates the division of the address electrodes (X1-Xn) into address electrode groups according to an embodiment of the present invention.

FIGS. 13a to 13c illustrate driving waveforms according to an embodiment the present invention.

FIG. 14 illustrates driving waveforms according to another embodiment of the present invention.

FIGS. 15a to 15c are expanded diagrams illustrating waveforms according to an embodiment of the present invention.

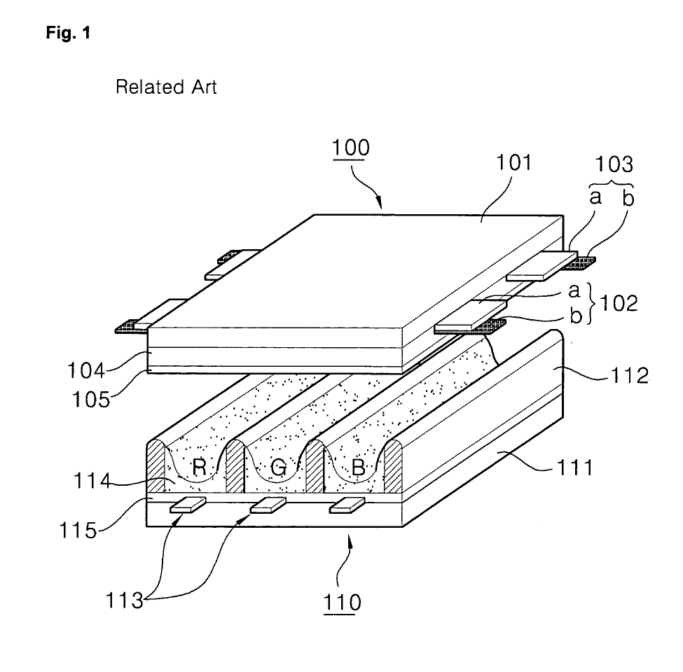

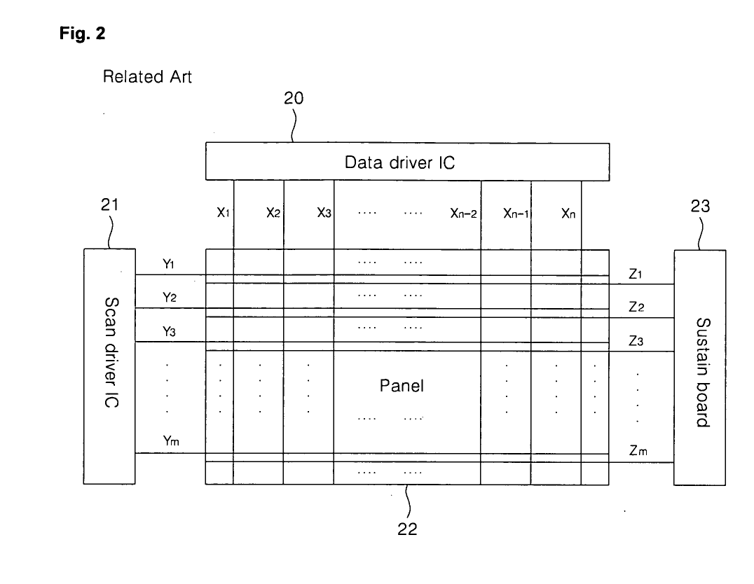

### DETAILED DESCRIPTION OF PREFERRED EMBODIMENTS

Reference will now be made in detail to embodiments of the present invention, examples of which are illustrated in the accompanying drawings.

The present invention provides a plasma display apparatus and method of driving same wherein the application time points of the data pulses applied to the address electrodes are different from the application time point of a scan pulse applied to the scan electrode during the address period in at least one sub-field of the frame.

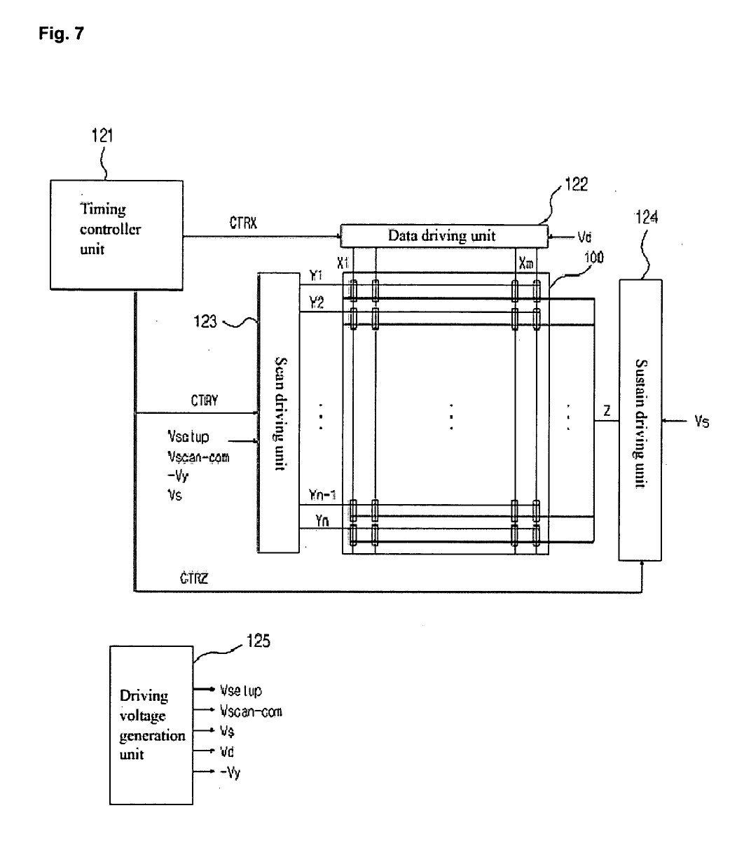

FIG. 7 illustrates a plasma display apparatus according to embodiments of the invention. The plasma display apparatus includes a plasma display panel 100, a data driver 122 for supplying data to address electrodes X₁ to Xₘ, a scan driver 123 for driving scan electrodes Y₁ to Yₙ, a sustain driver 124 for driving sustain electrodes Z which are common electrodes, a timing controller 121 for controlling the data driver 122, the scan driver 123, the sustain driver 124, and a driving voltage generator 125 for supplying the driving voltage required for each driver 122, 123, 124.

The plasma display panel 100 is formed of an upper substrate (not shown) and a lower substrate (not shown), which are combined with a predetermined gap in between. A plurality of electrodes, for example, scan electrodes Y₁ to Yₙ and sustain electrodes Z are formed in pairs in the upper substrate. Address electrodes X₁ to Xₘ, which cross the scan electrodes Y₁ to Yₙ and the sustain electrodes Z are formed in the lower substrate.

The data driver 122 receives data mapped for each sub-field by a sub-field mapping circuit after being inverse-gamma corrected and error-diffused through an inverse gamma correction circuit, an error diffusion circuit, or the like. The data driver 122 samples and latches the mapped data in response to a timing control signal CTRX from the timing controller 121, and then supplies the data to address electrodes X₁ to Xₘ.

The scan driver 123, under the control of the timing controller 121, supplies a ramp-up waveform and a ramp-down waveform to the scan electrodes Y₁ to Yₙ, during a reset period. In addition, the scan driver 123, sequentially supplies a scan pulse of scan voltage (−Vy) to the scan electrodes Y1 to Yn during the address period, and supplies a sustain pulse (sus) to the scan electrodes Y₁ to Yₙ during the sustain period. Accordingly, the timing controller controls the application time points of the data pulses applied to address electrodes X₁ to Xₘ and the scan pulses applied to the scan electrodes Y₁ to Yₙ.

The sustain driver 124, under the control of the timing controller 121, supplies a bias voltage (Vs) to the sustain electrodes Z during the set-down period and the address period. During the sustain period, the sustain driver 124 operates alternately with the scan driver 123 to supply a sustain pulse to the sustain electrodes Z. Furthermore, width of the sustain pulse supplied by the sustain driver 124 is controlled such that the width of the sustain pulse applied first during the sustain period is larger than that of other sustain pulse. In other words, the first sustain pulse supplied after the address period has a width greater than the width of another sustain pulse applied during the sustain period.

The timing controller 121 receives a vertical/horizontal synchronizing signal and a clock signal (not shown) and generates control signals CTRX, CTRY, and CTRZ for controlling the operation timing and synchronization of each driver 122, 123, 124. In particular, the data driver 122 and the scan driver 123 are controlled such that the address electrodes during at least one sub-filed of a frame are divided into a plurality of address electrode groups, and the application time point of the data pulses applied to at least one of the address electrode groups during the address period is different from that of a scan pulse applied to the scan electrode.

The data control signal CTRX includes a sampling clock for sampling data, a latch control signal, and a switch control signal for controlling the on/off time of an energy recovery circuit and a driving switch element. The scan control signal CTRY includes a switch control signal for controlling the on/off time of the energy recovery circuit and the driving switch element within the scan driver 123. The sustain control signal CTRZ includes a switch control signal for controlling on/off time of the energy recovery circuit and the driving switch element inside the sustain driver 124.

The driving voltage generator 125 generates the voltages necessary to driver the display panel, for example, a set-up voltage Vsetup, a scan common voltage Vscan-com, a scan voltage −Vy, a sustain voltage Vs, a data voltage Vd, and the like. These driving voltages may vary with the composition of the discharge gas or the structure of the discharge cells.

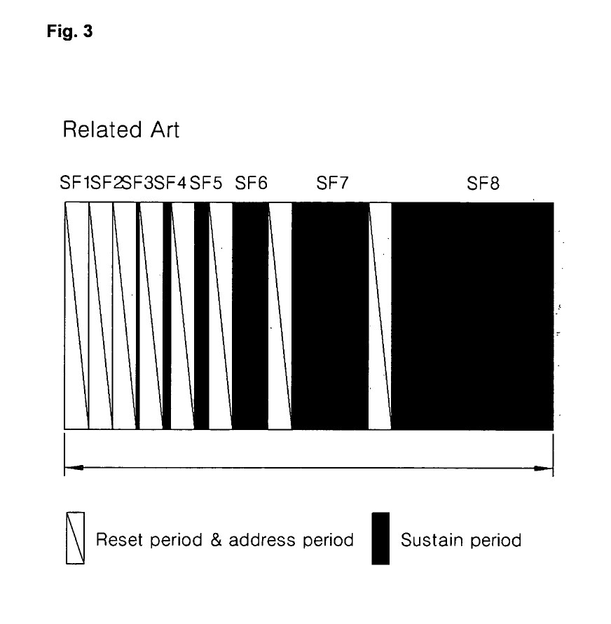

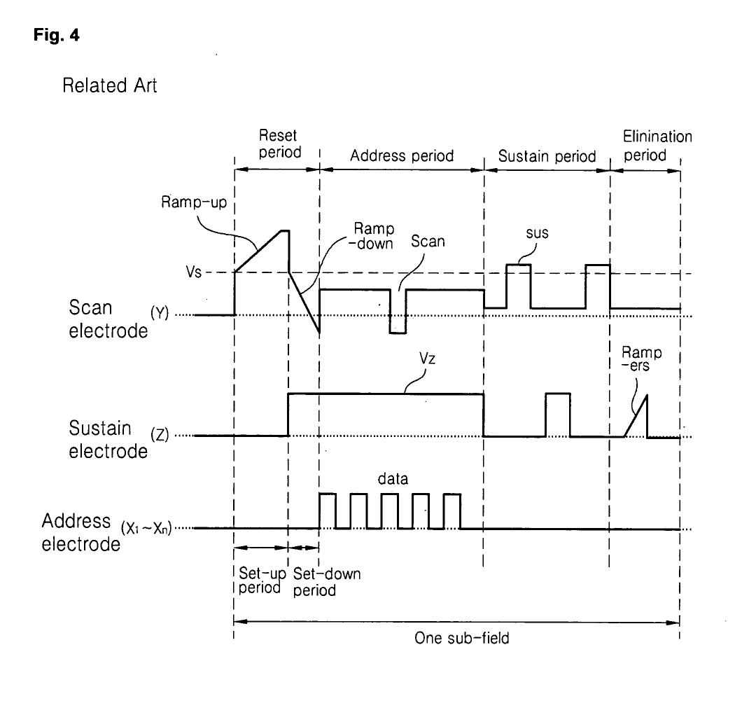

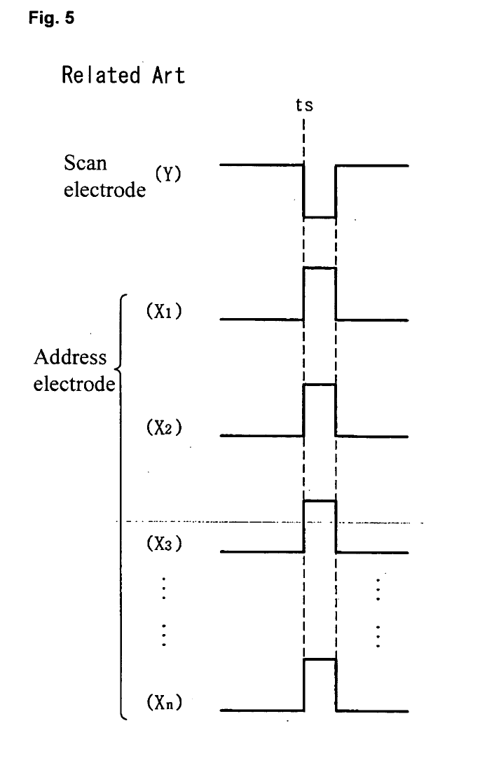

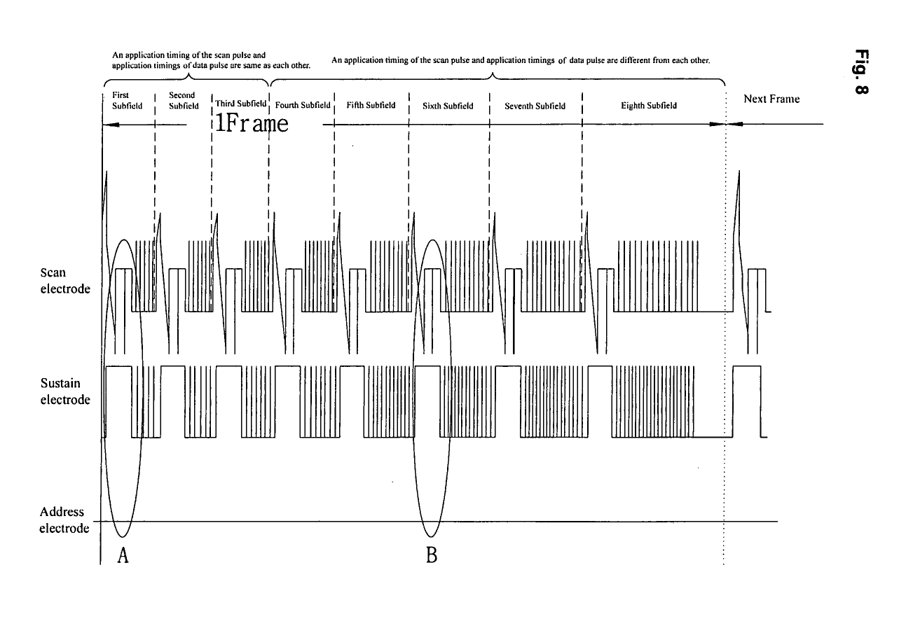

FIG. 8 illustrates driving waveforms utilized in the driving method according to an embodiment of the present invention. As illustrated, the application time points of the data pulses applied to the address electrodes during the address periods of the fourth through eighth sub-fields are different from the application time points of the scan pulse applied to the scan electrode during the address period of the fourth through eighth sub-fields. In the remaining sub-fields (i.e., the first through third sub-fields), the application time points of the data pulses applied to the address electrode are the same as the application time point of the scan pulses applied to the scan electrode during the address periods. Preferably, the sub-fields in which the data pulse application time point and the scan pulse application time are the same includes a predetermined number, for example 3, of the sub-fields having the lowest weighting value in order to prevent degradation of the jitter characteristic of the address discharge. For example, sub-field one through three where the frame is divided as illustrated in FIG. 3.

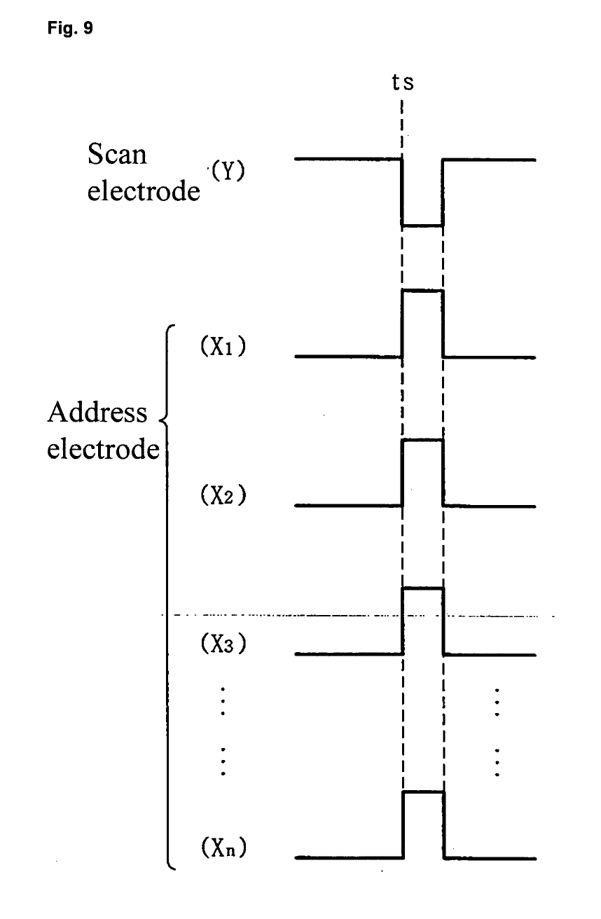

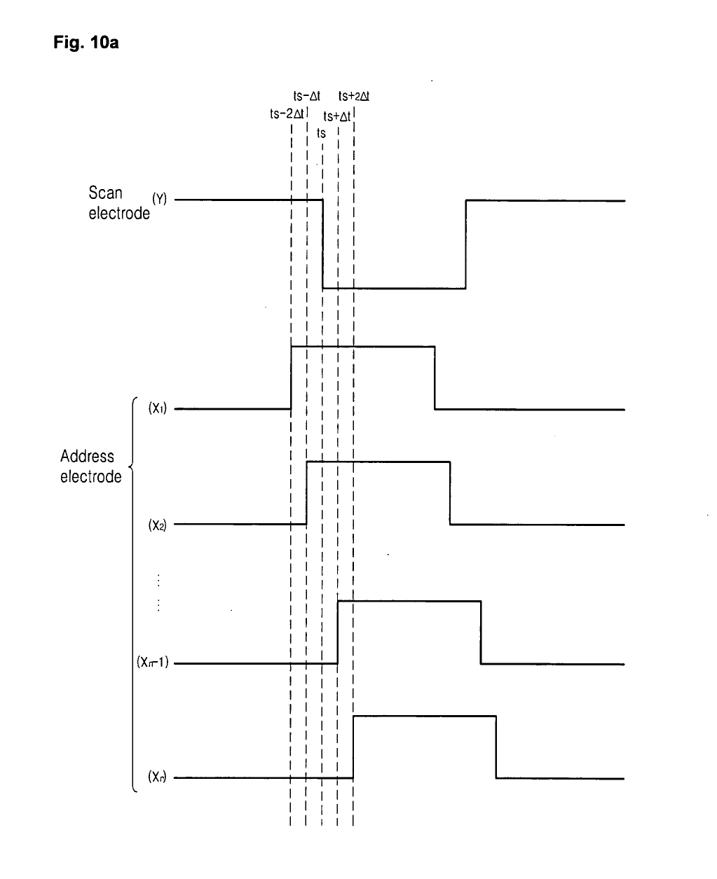

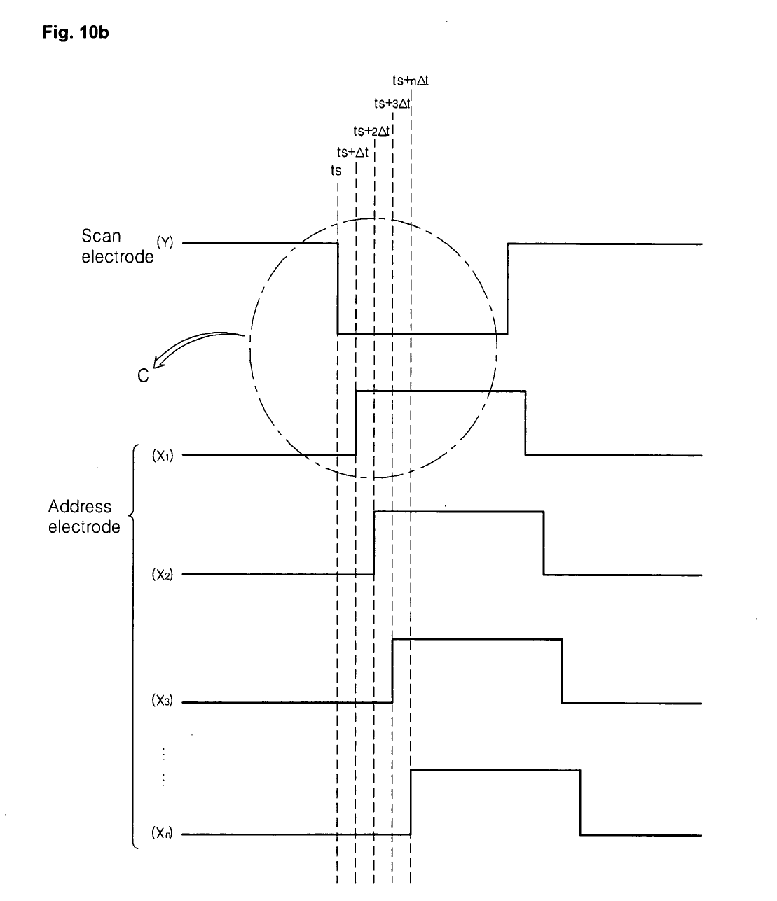

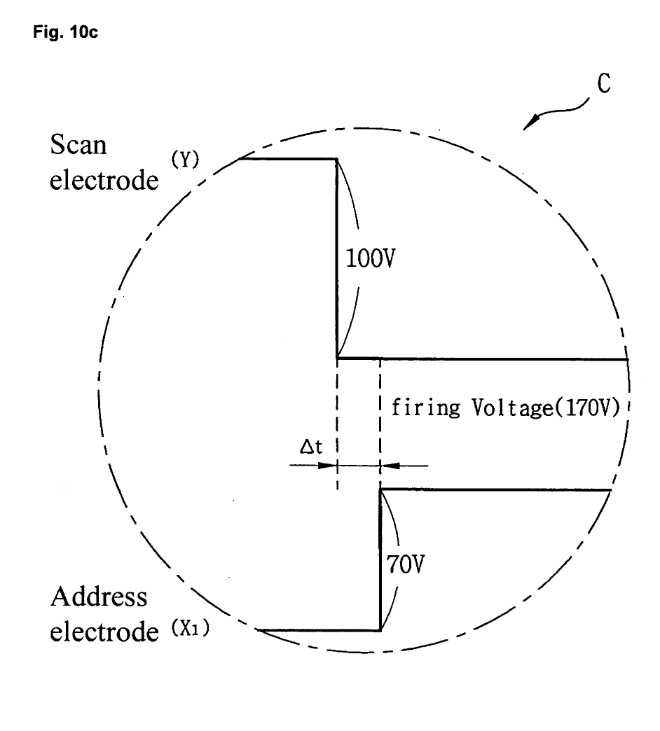

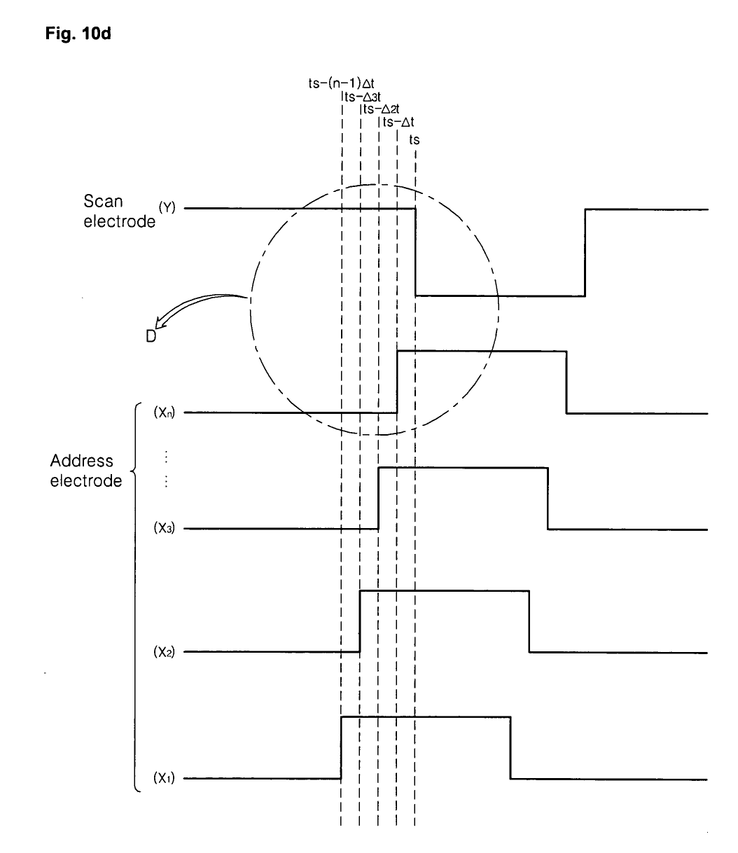

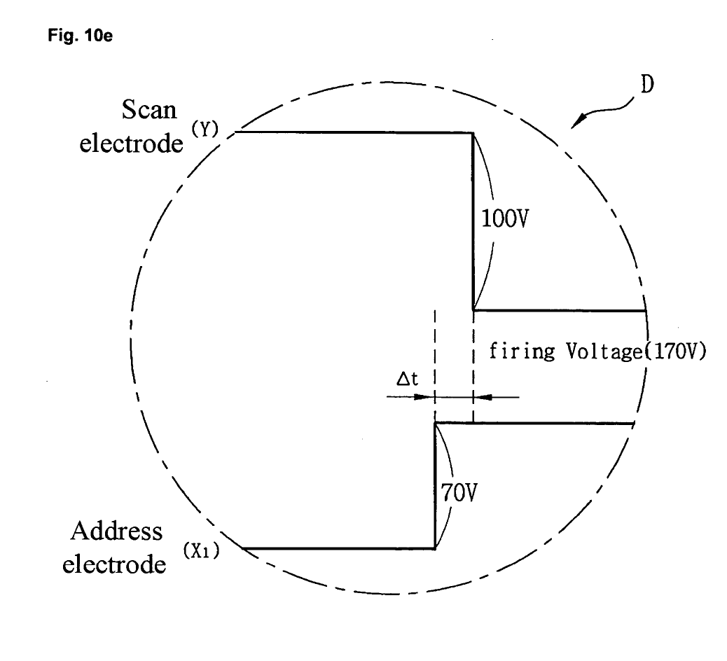

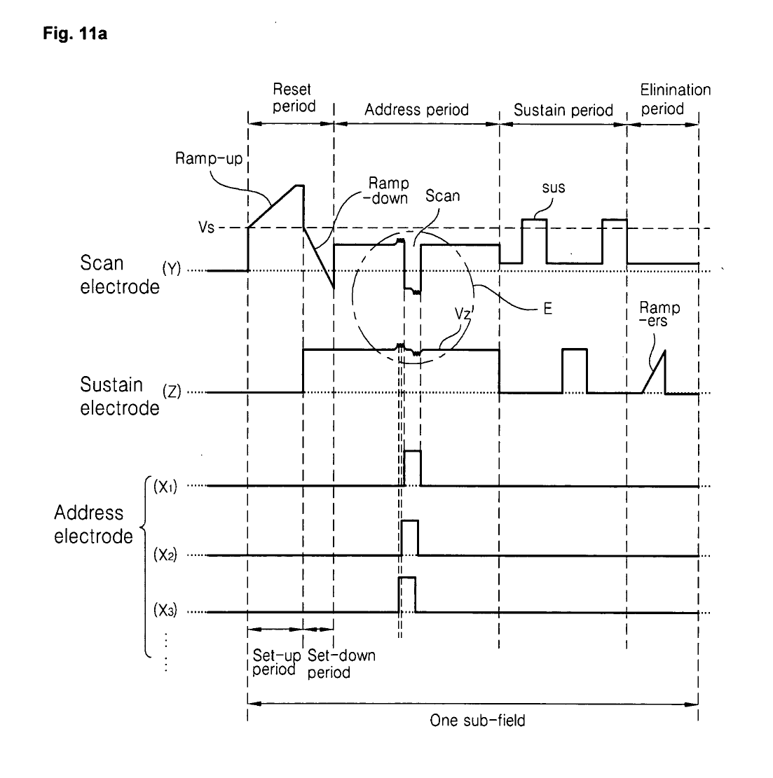

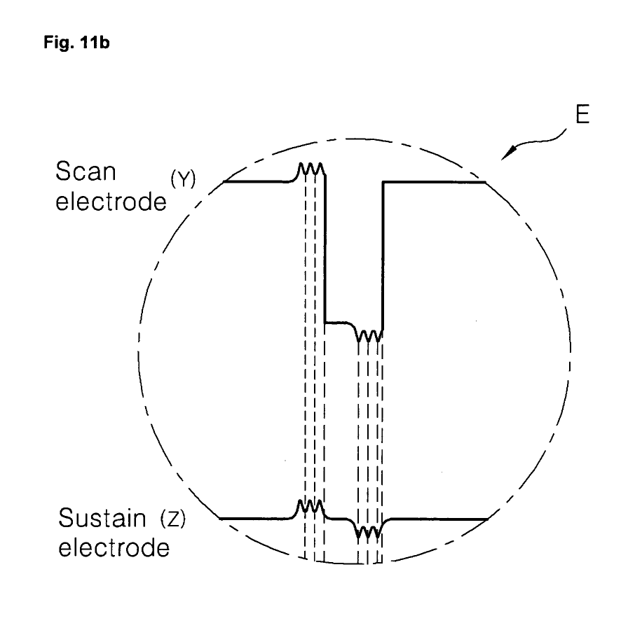

FIG. 9 is an expanded diagram of the scan pulse and data pulses applied during the address period of the first sub-field, in region A of FIG. 8. As illustrated, the scan pulse and the data pulses are applied at the same time (ts). In contrast, the driving waveforms applied during the address period of the sixth sub-field, i.e., region B of FIG. 8. are applied at different times as illustrated in FIGS. 10a and 10b.

As illustrated in FIG. 10a, the data pulses applied to the address electrodes X₁-Xₙ are staggered before and after the scan pulse is applied to the scan electrode by some predetermined factor Δt, according to the arrangement of the address electrodes. For example, assuming the scan pulse is to be applied at ts, then the application time point of the data pulse applied to address electrode (X1) would be ts−2Δt. Then, a data pulse is applied to the second address electrode X2 prior to the application time point of a scan pulse by Δt, or at the time point, ts−Δt. Likewise, at the time point ts+Δt, a data pulse is applied to the X(n−1) electrode, and at ts+2Δt, a data pulse is applied to the X(n) electrode.

Alternatively, the all the data pulse may be applied after the scan pulse, as illustrated in FIG. 10b. Referring to FIG. 10b, the application time point of the data pulses applied to the address electrodes X₁-Xₙ are set to be delayed with respect to the application time point of the scan pulse by some multiple of Δt based on the position of the address electrode. For example, assuming the scan pulse is applied to the scan electrode at the time point ts, then application time point of the data pulse applied to the address electrode X₁ is delayed with respect to the application time point of the scan pulse by Δt, i.e., at the time point ts+Δt. Then, the data pulse is applied to the second address electrode X2 is delayed with respect to the application time point of the scan pulse by 2Δt, and so on until the data pulse is applied to the last address electrode Xₙ at a time point of ts+nΔt.

FIG. 10c illustrates a detailed diagram of region C of FIG. 10b, assuming that the firing voltage of an address discharge is 170V, the scan pulse voltage is 100V, and the data pulse voltage 70V. In the region A, first, due to the scan pulse applied to the scan electrode Y, the voltage difference between the scan electrode Y and the address electrode X₁ becomes 100V. Then, some time, Δt, after application of the scan pulse, a data pulse is applied to the address electrode X1, increasing the voltage difference between the scan electrode Y and the address electrode X1 from 100V to 170V. The increased voltage difference between the scan electrode Y and the address electrode X₁ becomes a discharge firing voltage and thus an address discharge is generated between the scan electrode Y and the address electrode X₁

In addition, all the data pulses may precede the scan pulse as illustrated in FIG. 10d. Referring to FIG. 10d, the application time point of the data pulses applied to the address electrodes X₁-X_{N} are set to precede the application time point of the scan pulse by some multiple of Δt based on the position of the address electrode. For example, assuming the scan pulse is applied to the scan electrode at the time point ts, then application time point of the data pulse applied to the address electrode X₁ precedes the application time point of the scan pulse by nΔt, i.e., at the time point ts−nΔt. Then, the data pulse applied to the second address electrode X2 precedes the application time point of the scan pulse by (n−1)Δt, and so on until the data pulse is applied to the last address electrode Xₙ precedes the application time point of the scan pulse by Δt.

FIG. 10e illustrates a detailed diagram of region D of FIG. 10d, assuming that the firing voltage of an address discharge is 170V, the scan pulse voltage is 100V, and the data pulse voltage 70V. Because the data pulse applied to the address electrode X₁ before the scan pulse is applied, the voltage difference between the scan electrode Y and the address electrode X₁ is 70V. Then, some time, Δt, after the data pulse is applied the voltage difference between the scan electrode Y and the address electrode X₁ increases to about 170V because the scan pulse is applied. Accordingly, the voltage difference between the scan electrode Y and the address electrode X₁ becomes a discharge firing voltage and thus an address discharge is generated between the scan electrode Y and the address electrode X₁.

In FIG. 10a, Δt is defined as the time difference between the application time point of a scan pulse applied to the scan electrode Y and the application time point of the data pulses applied to the address electrodes X₁-Xₙ, whereas in FIGS. 10b and 10d Δt is defined as the difference between the application time points of the data pulses applied to the address electrode X₁-Xₙ. In both cases, the difference between the application time points of data pulses applied to adjacent address electrodes is constant, i.e. Δt. However, Δt may vary between sub-fields, and/or the difference between the application time point of data pulse applied to adjacent electrodes may vary. For example, the difference between the application time points of the data pulses applied to each of the address electrodes X₁-Xₙ during one sub-field may be constant, while during a different sub-field the difference between the data pulses varies.

Taking into account defined length of the address period, the difference between the application time point (ts) of a scan pulse and the application time point of the data pulse nearest to the application time point (ts) of the scan pulse is preferably greater than 10 nano seconds and less than 1000 nano seconds. Furthermore, considering the pulse width of a predetermined scan pulse, it is preferable that Δt is set to be less than the length of a predetermined scan pulse width and greater than 1 percent ( 1/100) of the predetermined scan pulse width. For example, if the pulse width of a the predetermined scan pulse is assumed as 1 μs, the difference between the application time points is preferably more than 1% of 1 μs, or 10 ns, and is less than 100% of 1 μs, or 1000 ns.

The difference between the application time point of the data pulses applied to adjacent address electrodes may vary. For example, if the time point of a scan pulse applied to the scan electrode Y is 0 ns, and a data pulse is applied to a first address electrode X₁ at a time point of 10 ns, the difference in the time points of the scan pulse and the data pulse is 10 ns. Then a data pulse is applied to the next address electrode X₂ at a time point of 20 ns, resulting in a difference between the time points of the scan pulse and the data pulse applied to the address electrode X₂ of 20 ns. However, the difference between the time points of the data pulses applied to the address electrodes X₁ and X₂ is 10 ns. Furthermore, to the next address electrode X₃, a data pulse is applied at a time point of 40 ns, and thus the difference in the time points of the scan pulse and the data pulse applied respectively to the scan electrode Y and the address electrode X₃ becomes 40 ns. Therefore, the time points of the data pulses applied to the address electrodes X₂ and X₃ respectively have a difference of 20 ns

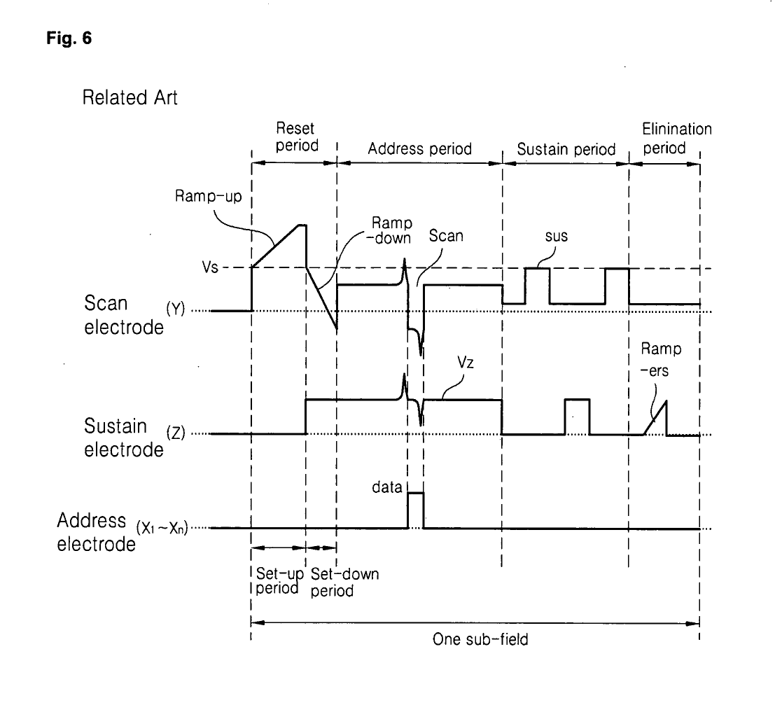

Referring to FIG. 10a, it can be seen that the noise in waveforms applied to the scan electrode and the sustain electrode is considerably reduced when compared to the noise in conventional driving methods as shown in FIG. 6. The reduced noise is illustrated in greater detail in FIG. 10b. At the point in time when the data pulse is abruptly raised, the rising noise occurring in the waveforms applied to the scan electrode and the sustain electrode is alleviated. Likewise, at the point in time when the data pulse falls rapidly, the falling noise occurring in the waveforms applied to the scan electrode and the sustain electrode is reduced

Therefore, the driving efficiency of a plasma display panel is maintained by stabilizing the address discharges generated during the address period. Furthermore, the degradation of the jitter characteristic is prevented by setting the application time points of the date pulses and the scan pulse to be the same in the sub-fields having relatively low weighting value among the sub-fields in the frame. Consequently, it is possible to apply a single scan method for scanning the entire panel with one driving unit by stabilizing the address discharge of a plasma display panel.

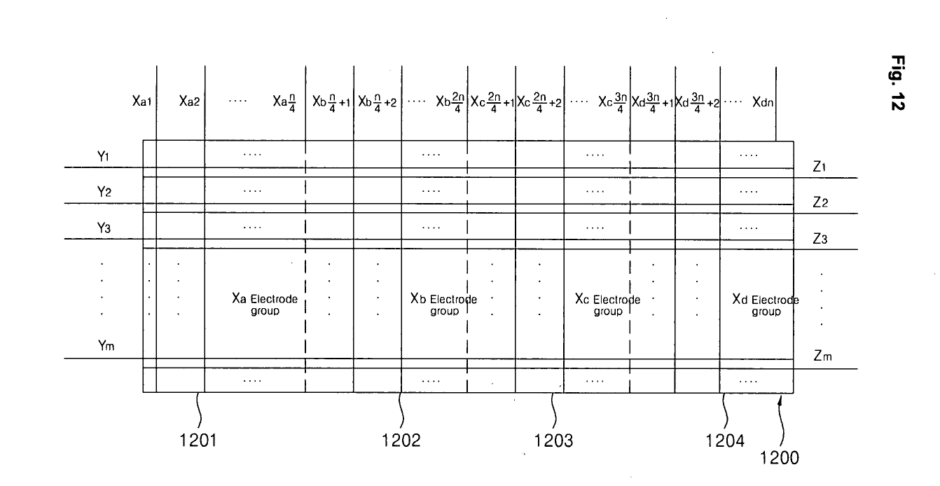

FIG. 12 illustrates a plasma display apparatus according to another embodiment of the invention, where the address electrodes X₁ to Xₙ are divided into a plurality of address electrodes groups. As illustrated in FIG. 12, the address electrodes X₁ to Xₙ are divided into, for example, four address electrode groups. Address electrode group Xa includes address electrodes Xa₁ to Xa_{n/4} (1201), address electrode group Xb includes electrodes Xb_{(1+n/4)} to Xb_{2n/4} (1202), address electrode group Xc includes electrodes Xc_{(1+2n/4)} to Xc_{3n/4} (1203), and address electrode group Xd includes electrodes Xd_{(1+3n/4)} to Xdₙ (1204). A data pulse is applied to the address electrodes belonging to at least one of the above electrode groups at a time point different from that of a scan pulse applied to the scan electrode Y. That is, while the application time point of a data pulse applied to all the electrodes (Xa₁ to Xa_{n/4}) belonging to the Xa electrode group is different from that of a scan pulse to the scan electrode Y, they are all the same within the Xa electrode group. In addition, while the data pulses applied to the electrodes belonging to the remaining electrode groups 1202, 1203, and 1204 can be applied at time points that are either the same or different from the time point of the scan pulse, all the time points are different from the application time point of a data pulse of the electrodes belonging to the first electrode group 1201.

In FIG. 12, the number of address electrodes belonging to each address electrode group (1201, 1202, 1203, 1204) is the same, however, the number of address electrodes belonging to each group may vary and the number may differ between groups. The number of address electrode groups N is preferably set to be more than two and less than the total number, n, of address electrodes, 2≦N≦(n−1).

According to the driving method of the second embodiment, like the first embodiment, the application time point of the scan pulse applied to the scan electrode is the same as the application time point of the data pulse applied to the address electrodes during the address period of a predetermined number of the sub-fields in a frame, and in the remaining subfields, the application time points of data pulses applied to at least one address electrode group is set to be different from the scan pulse application time point. Preferably the predetermined subfields are selected to prevent degradation of the jitter characteristics of the address discharge.

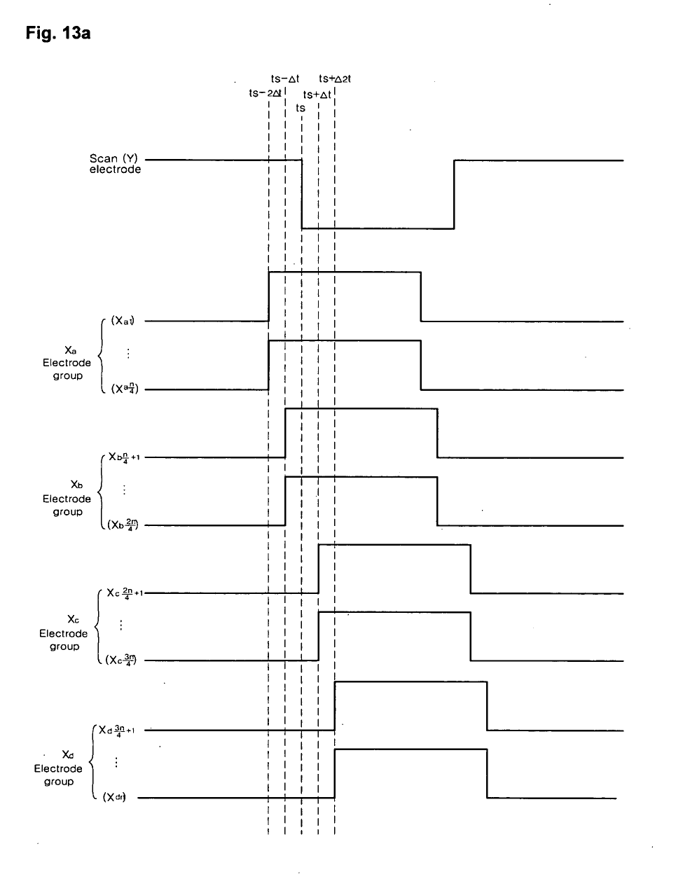

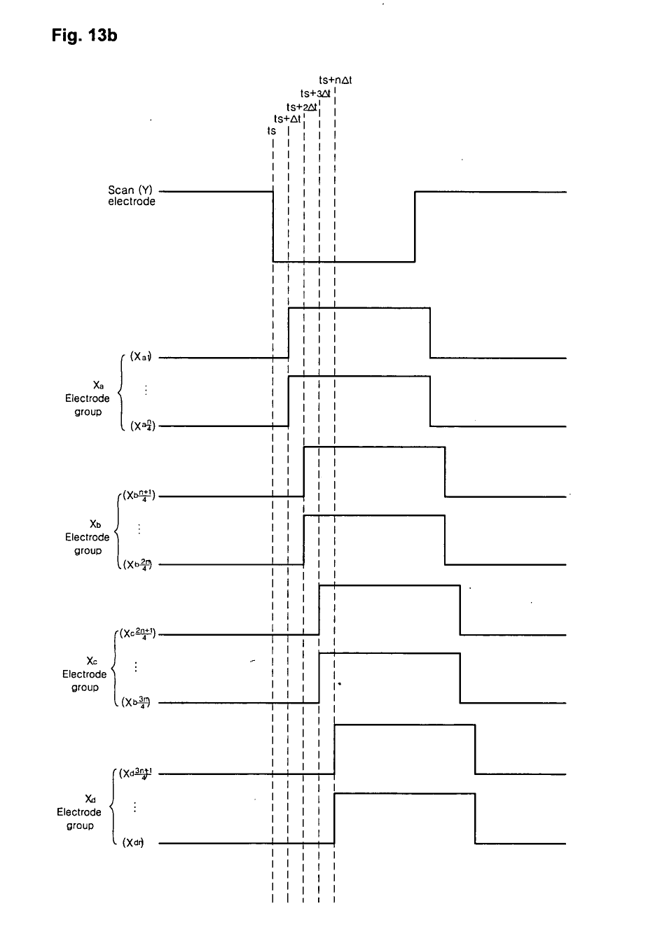

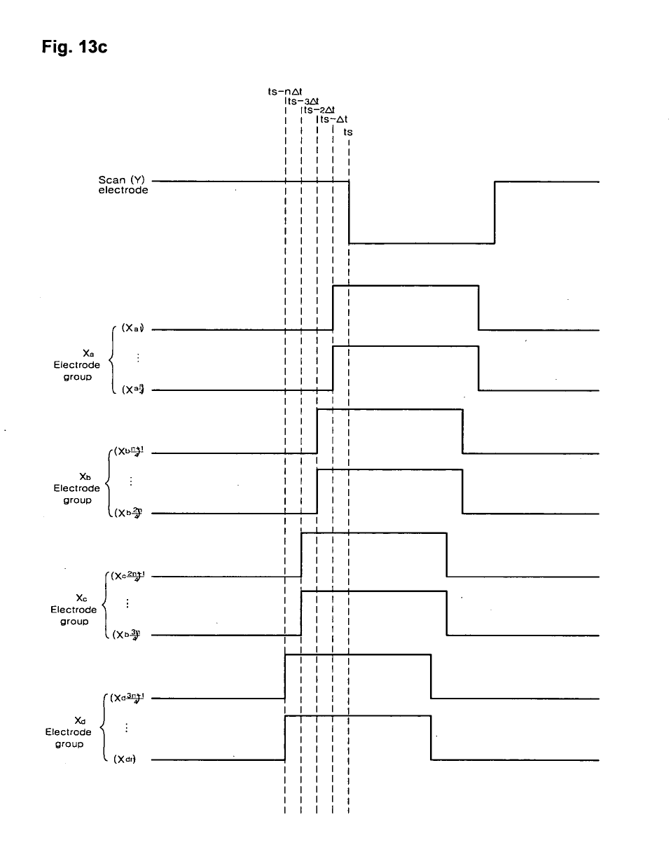

FIGS. 13a through 13c illustrate exemplary driving waveforms according to the driving method of the invention. As illustrated in FIGS. 13a through 13c, the data pulse application time points for the address electrode groups Xa and Xb are prior to the application time point of the scan pulse and the data pulse application time points for the electrodes of address electrode groups Xc and Xb are later than or delayed with respect to the scan pulse application time point. For example, as illustrated in FIG. 13a, assuming that the application time point of the scan pulse to the scan electrode Y is ts, the application time points for the address electrodes

$$X 1 to X \frac{n}{4}$$

in the address electrode group Xa are prior to the scan pulse a factor of 2Δt, or at the time point ts−2Δt. The application time points of the address electrodes

$$X \frac{n}{4} + 1 , X \frac{n}{4} + 2 to X \frac{n}{2}$$

included in the address electrode group Xb are prior to the scan pulse by a factor of C, or the time point ts−Δt. Furthermore, the application time points of the address electrodes

$$X \frac{n}{2} + 1 , X \frac{n}{2} + 2 to X \frac{3 n}{4}$$

in the address electrode group Xc are delayed with respect to the scan pulse by a factor of Δt, or at the time point ts+Δt, and the application time points of the address electrodes

$$X \frac{3 n}{4} + 1 , X \frac{3 n}{4} + 2$$

to Xn in address electrode group Xd are delayed by a factor of 2Δt, or at the time point ts+2Δt. However, the data pulse application time points for all the address electrode groups may be delayed with respect to the scan pulse application time point as illustrated in shown in FIG. 13b.

With reference to FIG. 13b, the application time points of all the data pulses applied to the plurality of address electrode groups Xa, Xb, Xc, Xd are later than the application time point of the scan pulse by a factor of nΔt, where n represented the number of the address electrode group. For example, assuming that the application time point of the scan pulse is ts, the application time point of the data pulses applied to the address electrodes included in the Xa electrode group is later than the scan pulse application time point by a factor of Δt, the application time point of the data pulses applied to the address electrodes included in the address electrode group Xb is later than the scan pulse application time point by a factor of 2Δt and so on. Accordingly the application time point for the data pulses applied to the address electrodes included in the electrode group Xd is later than the scan pulse application time point by a factor of 4Δt. Likewise, the application time points for the all the data pulses applied to the plurality of address electrode groups Xa, Xb, Xc and Xd, may be prior to the application point of the scan pulse by a factor of nΔt, where n represented the number of the address electrode group as illustrated in FIG. 13b.

In FIGS. 13a to 13c, the application time point of the scan pulse applied to the scan electrode is marked as ts, and the time difference between the application time point of the scan pulse ts and the application time point of the nearest data pulse is Δt, and a time difference between the application time point of the scan pulse ts and an application time point of the second nearest data pulse may be adjusted to be 2Δt, with Δt being maintained uniform. However, the application time points of data pulses applied to each address electrode group may be different respectively. For example, the time difference between the application time point of the scan pulse ts and an application time point of the nearest data pulse may be Δt, in one group, where as the difference between the application time point of the scan pulse ts and an application time point of the nearest data pulse may be 3Δt in another group. For example, if the scan pulse is applied to the scan electrode Y at 0 ns and the data pulses applied to the address electrodes of the Xa electrode group are applied at 10 ns, the time difference between the application time point of the scan pulse and the application time point of the data pulses is 10 nanoseconds. In addition, if the data pulses are applied to the address electrodes of the Xb electrode group at 20 ns, the time difference between the application time point of the scan pulse and the application time point of data pulses applied to the Xb electrode group is 20 ns, and the time difference between the application time point of the data pulses applied to the Xa electrode group and the application time point of the data pulses applied to the Xb is 10 ns. In addition, if the data pulses are applied to the address electrodes of the Xc electrode group which is a next address electrode group at 40 ns, the time difference between the application time point of the scan pulse and the application time point of the data pulses applied to the Xc electrode group is 40 ns, and the time difference between the application time point of the data pulses applied to the Xb electrode group and the application time point of the data pulses applied to the Xc electrode group is 20 ns.

If the application time point of the scan pulse applied to the scan electrode Y and the application time point of the data pulse applied to each address electrode group are different from each other as above, a coupling through a capacitance of the panel is decreased at each application time point of the data pulses applied to each address electrode group including address electrode X1˜Xn, thereby decreasing noise of a wave applied to the scan electrode and the sustain electrode.

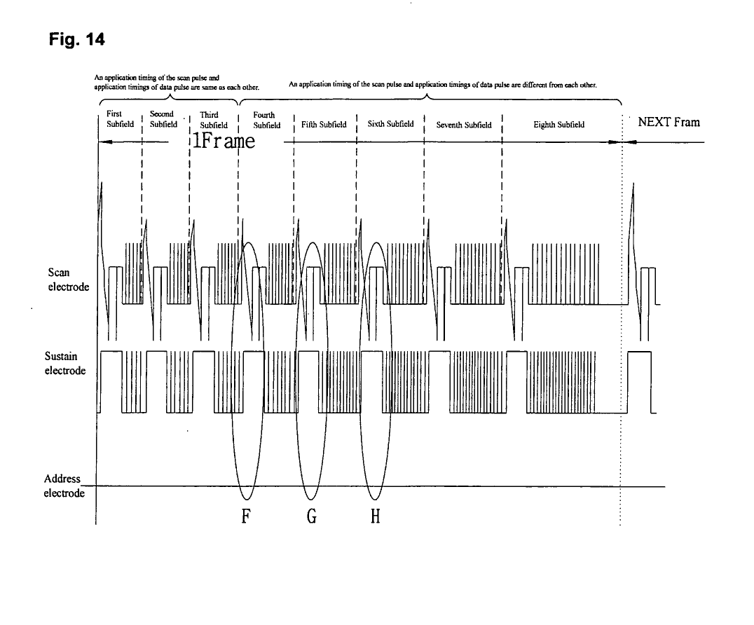

Although the above examples describe only the time difference between the data pulse application time points and the scan pulse application data point in a sub-field, the above application time points of the scan pulse and the data pulses applied to the address electrode X1˜Xn or the address electrode groups Xa, Xb, Xc and Xd may be different from each other in different sub-fields and/or frames, as illustrated in FIG. 14.

Referring to FIG. 14, in a predetermined number of sub-fields, preferably the sub-fields having the lowest weighting, the application time point of the scan pulse and the application time point of the data pulses is the same; and in at least one of the remaining subfields the time differences between application time points of the data pulses applied to adjacent address electrodes are the same while the application time point of the scan pulse and application time points of data pulses is different from each other; and in at least one other of the remaining subfields, the time difference between the application time points of the data pulses is different from the time difference between the application time points of data pulses of another subfield. For example, in a first subfield of the frame, the application time points of data pulses applied to address electrodes X₁˜Xₙ are different from an application time point of the scan pulse applied to the scan electrode Y, while the time difference between the application time points of adjacent data pulses is Δt. In a second subfield, the application time points of the data pulses applied to address electrodes X₁˜Xₙ are different from the application time point of the scan pulse applied to the scan electrode Y, and the time difference between the application time points of adjacent data pulses is 2Δt. Accordingly, the time difference between the application time points of the data pulses applied to adjacent address electrodes can be different in each sub-field of the frame, for example, they may be 3Δt, and 4Δt and so on.

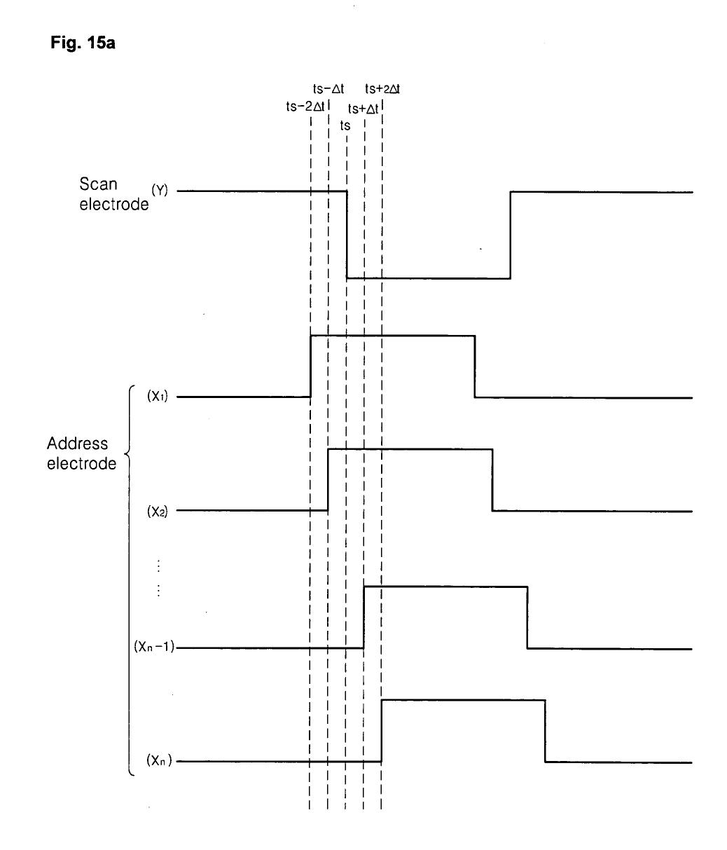

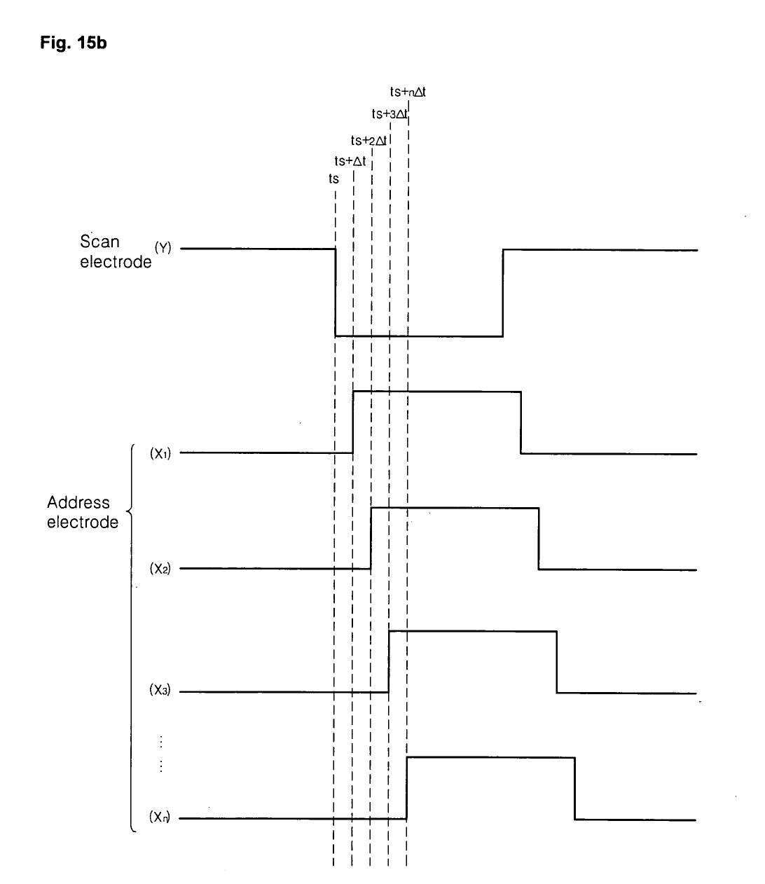

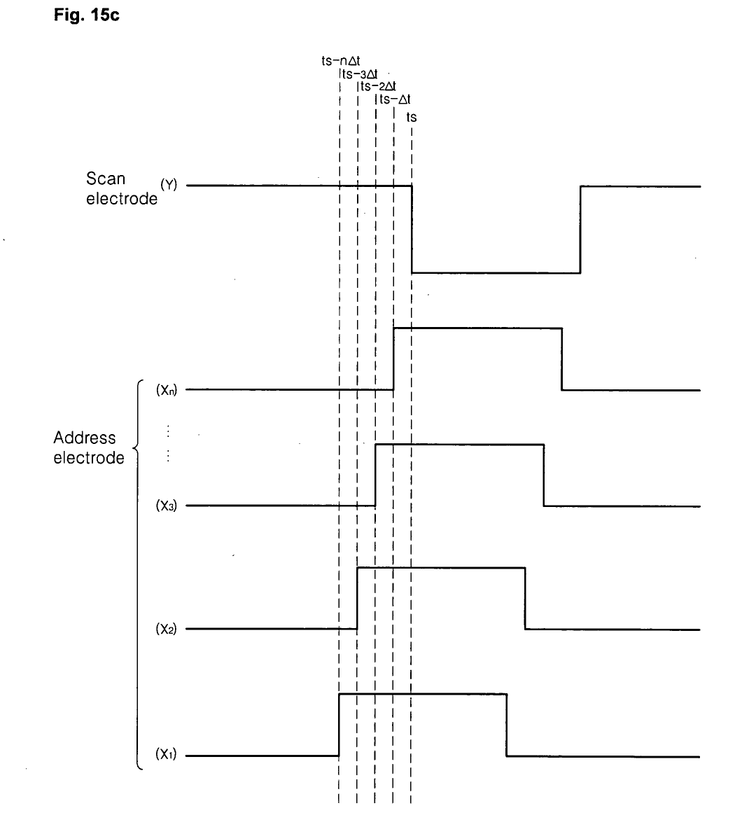

In the waveforms according to another embodiment of the invention, the application time point of the data pulses and the application time point of the scan pulse are the same in at least one subfield, and the application time points of the data pulses and the scan pulse are different in other sub-fields. For example, during the fourth sub-field, the application time points of data pulses are set before and after the application time point of the scan pulse as illustrated in FIG. 15a, whereas during the fifth sub-field all the application time points of data pulses are set before the application time point of the scan pulse as illustrated in FIG. 15b, and during the sixth sub-field all the application time points of data pulses are set after the application time point of the scan pulse as illustrated in FIG. 15c.

As above, if the application time point of the scan pulse applied to the scan electrode Y and the application time point of the data pulse applied to the address electrodes X1˜Xn are made different from each other in each subfield, a coupling is decreased through a static electricity capacity of the panel at each application time point of data pulse applied to the address electrodes X1˜Xn, thereby decreasing noise of a wave applied to the scan electrode and the sustain electrode.

The present invention may, however, be embodied in different forms and should not be constructed as limited to the embodiments set forth herein. For example, odd and even address electrodes of the address electrodes X1˜Xn may be grouped to be an address electrode group, and data pulses are applied to all the address electrodes in the same electrode group at the same timing, and application time points of data pulses to each electrode group are made different from an application time point of the scan pulse.

In addition, a method is possible where data pulses are applied to each electrode group at different time points from the application time point of the scan pulse by dividing the address electrodes X1˜Xn into a plurality of electrode groups at least one of which has a different number of address electrodes. For example, assuming that the application time point of the scan pulse is ts, a data pulse is applied to the address X1 electrode at the timing ts+Δt, and data pulses are applied to the address electrodes X2˜X10 at the timing of ts+3Δt, and data pulses are applied to the address electrode X11˜Xn at the timing of ts+4Δt, and like this the method of driving plasma display panel of the present invention can be changeable variously.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A plasma display apparatus comprising:
a scan electrode;
a plurality of address electrodes, the plurality of address electrodes crossing the scan electrode;
a scan driver for driving the scan electrode;
a data driver for driving the plurality of address electrodes; and
a controller for applying a data pulse to each of a plurality of data electrode groups in association with a scan pulse, wherein an application time point of the data pulse for at least one of the plurality of data electrode groups is different from an application time point of a scan pulse applied to the scan electrode during an address period of at least one subfield, where each of the plurality of data electrode groups includes one or more data electrodes.

2. The plasma display apparatus of claim 1, wherein during an address period of a predetermined number of sub-fields a data pulse is applied to each of the plurality of address electrodes at the same time a scan pulse is to be applied to the scan electrode.

3. The plasma display apparatus of claim 2, wherein the predetermined number of sub-fields includes the three sub-fields with the lowest weighting value.

4. The plasma display apparatus according to claim 1, wherein the application time point of a data pulse applied to more than one of the data electrode groups is prior to the application time point of a scan pulse applied to the scan electrode during the address period of the at least one sub-field.

5. The plasma display apparatus according to claim 4, wherein the application time point of a data pulses applied to all the data electrode groups is prior to the application time point of the scan pulse applied to the scan electrode, during the address period of the at least one sub-field.

6. The plasma display apparatus according to claim 1, wherein the application time point of a data pulse applied to more than one of the data electrode groups is later than the application time point of a scan pulse applied to the scan electrode during the address period of the at least one sub-field.

7. The plasma display apparatus according to claim 6, wherein the application time point of a data pulses applied to all the data electrode groups is later then the application time point of the scan pulse applied to the scan electrode, during the address period of the at least one sub-field.

8. The plasma display apparatus according to claim 1, wherein the number of the electrode groups is more than two and less than a total number of the address electrodes.

9. The plasma display apparatus according to claim 8, wherein each data electrode groups includes more than one address electrode.

10. The plasma display apparatus according to claim 9, wherein each date electrode group includes the same number of address electrodes.

11. The plasma display apparatus according to claim 9, wherein more than one of the data electrode groups includes a different number of address electrodes than the remaining data electrode groups.

12. The plasma display apparatus according to claim 1, wherein the application time point of the data pulses applied to each address electrode in a data electrode group is the same.

13. The plasma display apparatus according to claim 1, wherein a difference between the application time point of a scan pulse and the application time point of a data pulse applied nearest to the application time point of the scan pulse is the same between an address period of different sub-fields within a frame.

14. The plasma display apparatus according to claim 1, wherein a difference between the application time point of a scan pulse and the application time point of a data pulse applied nearest to the application time point of the scan pulse is different between an address period of different sub-fields within a frame.

15. The plasma display apparatus according claim 13, wherein the difference between the application time point of the scan pulse and the application time point of the data pulse nearest to the application time point of the scan pulse, is in the range of about 10 ns to about 1000 ns.

16. The plasma display apparatus according to claim 13, wherein the difference between the application time point of the scan pulse and the application time point of the data pulse nearest to the application time point of the scan pulse is more than about 1% and less than about 100% of the width of a predetermined scan pulse applied during the sub-field.

17. The plasma display apparatus according to claim 1, wherein a difference between application time points of adjacent address electrodes with one of the plurality of data electrode groups is the same.

18. The plasma display apparatus according to claim 1, wherein a difference between application time points of adjacent address electrodes with one of the plurality of data electrode groups is different.

19. The plasma display apparatus according to claim 1, wherein the difference between application time points of adjacent address electrodes within at least one of the plurality of data electrode groups is between about 10 ns to about 1000 ns.

20. The plasma display apparatus according to claim 1, wherein the difference between application time points of adjacent address electrodes within at least one of the plurality of data electrode groups is more than about 1% and less than about 100% of a predetermined scan pulse width.

21. A method of driving a plasma display panel, the plasma display panel including a scan electrode, a plurality of address electrodes crossing the scan electrode, and a controller, the method comprising:
dividing the plurality of address electrodes into a plurality of data electrode groups;
applying a scan pulse to the scan electrode during an address period of a plurality of sub-fields within a frame;
applying a data pulse to each address electrode within the plurality of data electrode groups in association with a scan pulse during the address periods of the plurality of sub-fields;
wherein during an address period of at least one of the plurality of sub-fields, the application time point of the data pulse applied to at least one of the data electrode groups is different from the application time point of a scan pulse applied to the scan electrode.

22. The driving method of claim 21, wherein during an address period of a predetermined number of sub-fields a data pulse is applied to each of the plurality of address electrodes at the same time a scan pulse is to be applied to the scan electrode.

23. The driving method of claim 22, wherein the predetermined number of sub-fields includes the three sub-fields with the lowest weighting value.

24. The driving method of claim 21, wherein the application time point of a data pulse applied to more than one of the data electrode groups is prior to the application time point of a scan pulse applied to the scan electrode during the address period of the at least one sub-field.

25. The driving method of claim 24, wherein the application time point of a data pulses applied to all the data electrode groups is prior to the application time point of the scan pulse applied to the scan electrode, during the address period of the at least one sub-field.

26. The driving method of claim 21, wherein the application time point of a data pulse applied to more than one of the data electrode groups is later than the application time point of a scan pulse applied to the scan electrode during the address period of the at least one sub-field.

27. The driving method of claim 26, wherein the application time point of a data pulses applied to all the data electrode groups is later then the application time point of the scan pulse applied to the scan electrode, during the address period of the at least one sub-field.

28. The driving method of claim 21, wherein the number of the electrode groups is more than two and less than a total number of the address electrodes.

29. The driving method of claim 28, wherein each data electrode groups includes more than one address electrode.

30. The driving method of claim 29, wherein each date electrode group includes the same number of address electrodes.

31. The driving method of claim 29, wherein more than one of the data electrode groups includes a different number of address electrodes than the remaining data electrode groups.

32. The driving method of claim 21, wherein the application time point of the data pulses applied to each address electrode in a data electrode group is the same.

33. The driving method of claim 21, wherein a difference between the application time point of a scan pulse and the application time point of a data pulse applied nearest to the application time point of the scan pulse is the same between an address period of different sub-fields within a frame.

34. The driving method of claim 21, wherein a difference between the application time point of a scan pulse and the application time point of a data pulse applied nearest to the application time point of the scan pulse is different between an address period of different sub-fields within a frame.

35. The driving method of claim 22, wherein the difference between the application time point of the scan pulse and the application time point of the data pulse nearest to the application time point of the scan pulse, is in the range of about 10 ns to about 1000 ns.

36. The driving method of claim 22, wherein the difference between the application time point of the scan pulse and the application time point of the data pulse nearest to the application time point of the scan pulse is more than about 1% and less than about 100% of the width of a predetermined scan pulse applied during the sub-field.

37. The driving method of claim 21, wherein a difference between application time points of adjacent address electrodes with one of the plurality of data electrode groups is the same.

38. The driving method of claim 21, wherein a difference between application time points of adjacent address electrodes with one of the plurality of data electrode groups is different.

39. The driving method of claim 21, wherein the difference between application time points of adjacent address electrodes within at least one of the plurality of data electrode groups is between about 10 ns to about 1000 ns.

40. The driving method of claim 21, wherein the difference between application time points of adjacent address electrodes within at least one of the plurality of data electrode groups is more than about 1% and less than about 100% of a predetermined scan pulse width.
